(19) United States
(12) Patent Application Publication
(10) Pub. No.: US 2009/0240840 A1
(43) Pub. Date: Sep. 24, 2009

(54) METHODS AND APPARATUS FOR CONFIGURING INTERFACE UNITS

(76) Inventors: Christopher Kevin Habben, Cheltenham (GB); Andrew Peter Reynolds, Gloucestershire (GB); Timothy John Roberts, Cheltenham (GB)

Correspondence Address: General Electric Company;GE Global Patent Operation, PO Box 861, 2 Corporate Drive, Suite 648, Shelton, CT, 06484, US

(21) Appl. No.: 12/299,717

(22) PCT Filed: Apr. 26, 2007
(86) PCT No.: PCT/GB07/01548

§ 371 Date: Apr. 3, 2009

(30) Foreign Application Priority Data
May 3, 2006 (GB) 0908667.2

(51) Int. Cl. G06F 3/00

(52) U.S. Cl. 710/10

(57) ABSTRACT

A toolset comprising a set of computer software programs that support a family of configurable remote interface units for use in an aircraft. The software includes configuration data as to the function each unit is to perform, generic function templates defining how a function should be structured and template instances derived from the generic function templates. Specific template instances are selected that are compatible with a specific interface unit.

This invention relates to methods and apparatus for configuring interface units.

The invention is more particularly, but not exclusively, concerned with methods and apparatus for configuring interface units used in aircraft.

It is known for aircraft to be provided with a number of remote interface units, or RIUs, to convert data from different sensors into a form suitable for supply to the aircraft databus, and to convert command or control signals on the databus into a form suitable for controlling an item of aircraft equipment. Preferably the RIUs are each of an identical hardware construction but are programmed with software suitable for the particular application in which the RIUs are to be implemented. This reduces the cost of providing the RIUs and enables a reduced number of spares to be stocked. It may also enable an RIU configured for one function to be reconfigured to assume a different function if necessary.

One problem with the RIUs is that their reprogramming requires specialist skills and detailed knowledge of the operation of the units and also requires independent testing and verification.

It is an object of the present invention to provide an alternative method and apparatus for configuring interface units.

According to one aspect of the present invention there is provided a method of configuring an interface unit including the steps of providing software including configuration data providing information as to the function the unit is to serve, the software including generic function templates defining how a function should be structured and template instances derived from the generic function templates, and the method further including the step of selecting specific template instances that are compatible with a specific interface unit.

The method may include providing an output of a configuration data table in binary-coded form. The method may include an analyse mode arranged to determine whether a set of functional requirements can be implemented by a target interface unit. The generic function templates may include an interface to one or more of the following: a sensor, a limit switch and a solenoid valve. The generic function templates preferably have values that can be adjusted by the user within pre-defined constraints. The template instances preferably have their own dedicated set of interface resources.

According to another aspect of the present invention there is provided apparatus for performing the method of the above one aspect of the present invention.

According to a further aspect of the present invention there is provided an interface unit configured by a method according to the above one aspect of the present invention.

According to a fourth aspect of the present invention there is provided a data storage medium containing software for a method according to the above one aspect of the present invention.

Other aspects of the present invention will become apparent from the following, which is a description of one particular embodiment of the invention.

The RACE Toolset is a set of computer software programs, produced in support of a family of configurable remote interface units (RIUs) for use in aircraft. The RACE Toolset enables a set of RIUs to be configured, in a simple straight-forward manner, to perform an application-specific set of data conversion functions as part of a complete control system.

RACE stands for RIU Analysis & Configuration Engine, and is the name given to the principle component of the Toolset. The term RACE has been used herein to refer to the whole toolset except where it is clear that the term refers only to the specific core component.

The principal output of RACE is a configuration data table (CT), in the form of a binary-coded computer file, which is downloaded into all RIUs in an application ship set, via a serial data link (using a PC-based RIU Downloader tool). The CT is stored in each unit's non-volatile memory. Each RIU interprets the CT at run time to determine what functionality is to be performed, depending on its identity within the ship set.

The RACE Toolset differs from other tools and processes that have been produced to configure RIUs in that it allows the configuration process to be carried out by the end-users (i.e. vehicle system integrators) without the need for the intervention of the developers of the RIU hardware. The principle attributes of RACE Toolset which facilitate this are:
1. The configuration process, utilising the toolset, can be undertaken without requiring an intimate knowledge of the working of the RIU; and
2. The integrity of the process is such that the resulting CTs can be considered suitable for immediate use without the need to independently verify the correct operation of RACE via test and/or inspection.

As well as producing CTs, RACE can also be used in an Analysis mode. In this mode RACE can be used to determine whether a set of functional requirements can be implemented by a target set of RIUs and what proportion of the total RIU resource would be utilised. RACE is also able to determine which of the available resources is best able to fulfil additional functional requirements based on user modifiable discriminators such as candidate RIU proximity, the distribution of available spare resources across the ship set, and on the observation safety-related segregation rules.

Thus, by using the RACE tool set, the RIU owner is able repeatedly to reconfigure the device for different functionality without incurring any cost or delay arising from the procurement of additional design services from the equipment supplier.

The operation of the RACE tool set depends on three conceptual objects:
Generic Function Templates, referred to simply as Templates;
Template Instances; and
Superset

### Generic Function Templates

Generic Function Templates are a set of standard, pre-defined solution models (descriptions) to typical low-level interfacing problems, expressed in terms of Generic RIU Primitives. Typical examples of generic functions are an interface to an industry standard temperature sensor; a discrete input function for sensing the open/closed state of a limit switch; or an output function capable of driving an electrically-actuated solenoid valve to a position commanded by a control computer.

There are three categories of RIU Primitive from which Templates are constructed:
hardware primitives (I/O resources) from which the electrical interface is constructed;
software library functions which are used to build software functionality; and
data (interface) types from which a more complex data structure can be defined to represent the information associated with the function.

The range of Templates that can be supported by a given RIU hardware platform are described in an I/O Catalogue, a supporting document supplied with the RACE Tool-set. The I/O catalogue outlines each Template in sufficient detail to show clearly how the interface connects to the sensor (or effector), what data processing is performed and how the associated data may be interpreted. The performance and operating boundaries of the generic function are fully specified.

There can be a number of attributes associated with each Template that can have their values adjusted within pre-defined constraints for each instance of the Template that is implemented. These are referred to as User-Defined Characteristics (LDCs). The I/O catalogue describes the purpose of each UDC and itemises the range of values each is constrained by.

### Template Instances

A generic template does not delineate a specific function utilising a specific set of unit resources (I/O pins, memory, processing throughput etc) but rather it describes how such a function should be structured. A specific example of a Generic Function Template is referred to as a Template Instance.

Each Template Instance is a tangible function, which inherits its structure from its parent Template but has its own dedicated set of RIU resources such as RIU I/O primitives (pins), associated instances of S/W library functions, and RAM. An RIU hardware platform is thus capable of concurrently supporting a number of instances of a given template, depending on the total quantity of each required type of resource provided by the platform.

### Superset

A superset can be thought of as a pre-defined and pre-engineered CT for a given hardware platform (RIU), which comprises the set of all Template Instances of all Generic Function Templates supportable by that platform. The superset CT itself is not a viable application since it will contain many template instances that compete for the same RIU resources. However, a carefully selected subset of the Superset, where no Template instances whose resources overlap with another, are chosen concurrently, can form the basis of a viable application, as long as the total loading on shared RIU resources, such as processor throughput, does not exceed the total available.

The contents of the Superset are described in the Unit ICD, another of the supporting documents supplied with the tool-set.

### Principle of Operation

RACE provides three modes of operation:
Generate
Analyse
Auto-Allocate

### Generate Mode

The main function of RACE is to compile automatically a CT for a set of RIUs in order to configure the RIUs to provide the required functionality. This it does using two principle sources of information, which it takes as its inputs:
A Resource Database, which defines the characteristics and capabilities of the specific hardware platform, and contains a definition of an associated superset CT, along with other ancillary information; and
An Input File, which contains the application requirements including a list of the units to be used for the application, and for each unit the required subset of Template Instances chosen from the Superset, and also a list itemising and detailing a set of serial bus messages that the unit will either receive or transmit at run time

The Resource Database is provided by the equipment supplier with the RACE tool set. Separating this information out into a separate input file, rather than embedding it within RACE, allows the toolset to be easily adapted for use with any product from the RIU product family. It also allows for a Superset to be tailored for individual products and/or customers needs.

The input File is compiled by the end-user. Each Template Instance selected from the Superset is associated with a specific unit of the ship set and is reserved for a particular aircraft function. In fact it is more correct to say that the Input file contains a list of aircraft functions and that each function is allocated to a unit and template instance. Each Template Instance selected for use can be tailored in the following ways:
The values of its UDCs can be specified, subject to the constraints specified in the I/O Catalogue;
The period between successive invocations of the associated processing functions can be chosen from a range of allowed periods; and
The mapping of its data interfaces to message data blocks can be specified

In addition the following must be specified for each message listed in the input file:
Its type, chosen from a range of message types specified in the I/O Catalogue;
Its associated data block(s) & their sizes; and
The period between successive invocations of the associated message processing functions, also chosen from the range of allowed periods.

When the RACE tool is commanded to ‘Generate’, it compiles a CT which comprises, for each RIU in the set, a schedule of the specified functionality to be invoked, at the required rate and with the required UDC values implemented; it includes all supporting housekeeping functionality necessary to support the basic operation of the machine. It only does this as long as the following holds true:
the Input file is complete and compliant with the required format;
the required functionality does not oversubscribe the available ship-set resources; and
of those Template Instances selected from the superset for each unit, none are competing for the same (non-shareable) resource.

### Auto-Allocate

The RACE software/method may also be invoked in Auto-Allocate mode. In the first instance, the Input file may list required application functions, identifying a Template for each selected from those described in the I/O catalogue so as to scope the required functionality. It may, however, omit the unit and/or Template Instance allocation for some or all of the functions. In this scenario RACE can be used to suggest a candidate Unit and Template Instance for each incomplete function.

Additional information can be specified for each function in the Input file, such as spatial data and system safety related (i.e. segregation) attributes. This allows RACE to exercise user-defined auto-allocation rules during Auto-Allocate mode, giving the end-user some influence over the auto-allocation process.

As well as the Input file and Resources Database, a third input is required to support Auto-Allocate—the Configuration file. This is modified by the end-user to affect RACE runtime operation and is compiled from a default provided by the equipment supplier. The principle contents of the Configuration file are:
RACE Operational settings
User-defined Auto-Allocation Rules and Definitions

The results of Auto-Allocation are written back into a copy of the Input file.

In all three modes of operation RACE reports status and produces a log of detailed process messages to aid the user in analysing the outcome of the run.

### Analyse

A set of application requirements specified in an Input file can be analysed by the RACE software when invoked in Analyse mode. In this mode, RACE firstly checks whether the Input file has been formatted correctly. Secondly, it determines whether all the functions listed can be implemented as specified by the target ship set (also defined in the Input file) without over-consuming any of the available resources or breaking user-defined allocation segregation rules, specified in the Configuration file. The quantity of each type of resource consumed in each unit is also computed.

All three inputs files are required to support the Analyse mode. The results are written back into a copy of the Input file.

### RACE Components

The RACE Toolset comprises a number of component programs. These are:
RACE
RaceUI
RaceVF
CT2Bin

### RACE

RACE is the principle component of the Toolset. It performs the key functions of Analyse, Auto-Allocate and Generate. RACE is invoked via the command line in one of three modes of operation: Analyse, Auto-Allocate and Generate. All Operational parameters are passed in the command line including the locations of the inputs and outputs.

The inputs to RACE are the Resource Database, The Input File and The Configuration File. The last is only required for Analyse and Auto-Allocate modes.

The output of RACE output is either the RACE Output File, which is a copy of the input file populated with the results of Analyse and Auto-Allocate mode, or a source CT file if RACE is invoked in Generate mode. The source CT file is a high-level, text-based version of the final binary CT in human-readable form. The format is similar to an assembler language with capability to support symbolic referencing and comments.

### RaceUI

The RACE Toolset is designed to operate as a ‘plug-in’ to another program that provides a user interface. The toolset can, however, be used standalone, in which case the RaceUI component provides a user interface. RaceUI provides the user with the following facilities:
Create/Edit/Preview a RACE Input file
Create/Edit/Preview a RACE Configuration file
Invoke or Abort RACE in Analyse, Auto-Allocate or Generate mode.
Preview a RACE Output file or log file

RACEUI uses a Resource Database to constrain the user to valid data entry during edit sessions on the Input File. RaceUI passes the location of the same files to RACE when it is invoked.

### RaceVF

RaceVF is an independent program, called by RACE in Generate mode. Its function is to verify that the Output of RACE, the Source CT, is 100% compatible with the information specified in the Input file and the Resource Database. In this way, it verifies that RACE has operated correctly and assures that the source CT has sufficient integrity for safety critical applications. In the event that RaceVF finds an incompatibility, the final step of the Generate Process is aborted and no downloadable CT is produced.

### CT2Bin

The final step in the Generate process is to convert the source CT into a downloadable binary version. This is preformed by CT2Bin which operates like a cut-down compiler. CT2Bin is invoked by RACE during the Generate process.

The inputs to CT2Bin are a Source CT produced by RACE and an enable token produced by RaceVF.

The output is a binary file suitable for download to the target hardware which CT2Bin only produces if the token is present and valid.

1.-10. (canceled)

11. A method of configuring an interface unit, the method comprising:
providing software including configuration data;
providing information as to a function the interface unit is to serve, the software including generic function templates defining how each function should be structured and template instances derived from the generic function templates'
selecting specific template instances that are compatible with the interface unit; and
providing an output of a configuration data table in binary-coded form.

12. The method of claim 11, further comprising:
determining whether a set of functional requirements can be implemented by a target interface unit.

13. The method of claim 11, further comprising:
checking for correct formatting of an input file.
